(19) United States
(12) Patent Application Publication
(10) Pub. No.: US 2003/0001030 A1
(43) Pub. Date: Jan. 2, 2003

(54) Flexible charged powder particle application device

(76) Inventor: Peter C. Buscemi JR., Rutland, VT (US)

Correspondence Address: John J. Welch, Jr., Esq., 8 E. Center Street, Rutland, VT, 05701, US

(21) Appl. No.: 09/733,714

(22) Filed: Dec. 11, 2000

(51) Int. Cl. B05B 5/00

(52) U.S. Cl. 239/698; 239/697; 239/690; 239/587.1; 239/588; 239/426; 239/434

(57) ABSTRACT

A flexible charged powder particle application device consisting of a resistor unit in contact with a power source on one side thereof and with wiring on a second side thereof, the resistor being found within an electrode block unit with a centerhole and connected to an electrode block extension unit with a centerhole all within housing and with the wiring being insulated within flexible tubing material being attached at one end to splines on an end of the extension unit such that the tubing is amenable to carriage within it of the wiring as well as accommodating within it, a flow of powder particles introduced under pressure into the centerholes such that charge from the power source via the wiring and the powder particles under pressure are amenable to concomitant expulsion from the tubing held at a second end by splines on an electrode hub holding an electrode base and electrode and adapter nozzle via a held base bushing and adapter screw lock into and about the housed electrode out through the hub for ultimate application to a metallic surface.

### CROSS REFERENCES TO PRIOR OR PARENT APPLICATIONS

There are no prior or parent applications to which the instant invention relates.

### FEDERALLY SPONSORED RESEARCH AND DEVELOPMENT

There is no federally sponsored research and development to which the instant invention relates.

### BACKGROUND OF THE INVENTION

1. Field of the Invention

The instant invention is within that field of devices serving to facilitate the application of charged powder particles to metallic surfaces.

2. Related Art

Your inventor is aware of no prior art that anticipates the instant invention.

### SUMMARY OF THE INVENTION

1. A Brief Description of the Invention:

The invention consists of an electrode block within which there is affixed a 15 meg resistor. The resistor is in contact with an external electrical power source via a contact ring unit. Wiring is attached to the resistor opposite to where the resistor is in contact with the contact ring. An electrode block extension unit is affixed anteriorly to the electrode block. Flexible tubing is affixed anteriorly to the electrode block extension unit. A hollow central through hole in the electrode block and one in the electrode block extension unit as well allows for the flow of powder particles under pressure into the flexible tubing also holding the wiring leading from the resistor. A hollow threaded sleeve unit envelopes the electrode block and electrode block extension unit. The wiring within the flexible tubing leads to an electrode contact via an electrode base unit to which there is anteriorly attached an electrode unit fitted with the contact all within a threaded electrode hub to which a base bushing unit is threadably fitted. The base bushing unit functions to hold in place, the electrode base unit, the electrode unit and an adapter nozzle unit within the electrode hub. An adapter screw lock unit in turn holds the base bushing unit in place at the front of the electrode hub. The invention accommodates use of a so-called flat jet adapter nozzle or an open-ended adapter nozzle. The open-ended adapter nozzle serves to accommodate insertion of a corona deflector unit onto the anterior end of the electrode unit. Powder particles under pressure entering the central through holes in the electrode block and electrode block extension unit and then coming up through the flexible tubing then pass through a center through hole in the electrode hub unit then around and about the electrode, through the base bushing unit via the adapter nozzle and exit out about the frontal aspect of the jet where they invariably come into contact with the charged outermost end of the stiff linearly shaped anterior tip of the electrode. In this way, then charged powder particles are readily amenable to adherence to the surface of any metallic object to which one would be seeking to apply such a coating of paint.

2. An Object of the Invention:

Current state of the art charged powder paint application devices are stiff and inflexible. There is no device within the aegis of the prior art that is in any way flexible so as to permit consistent, dependable and even coating of irregularly shaped metallic surfaces or pieces characterized by the presence of obstacles or corners.

The instant invention in view of its new and unique flexible tube component instantly serves to solve the problem of permitting consistent, dependable and even coating of irregularly shaped metallic surfaces or pieces.

In view of the foregoing, the instant invention, respectfully submitted is not only new and unique, but is likewise useful to the extent that it is veritably revolutionary in the art of powder pain application devices.

### A DESCRIPTION OF THE DRAWINGS

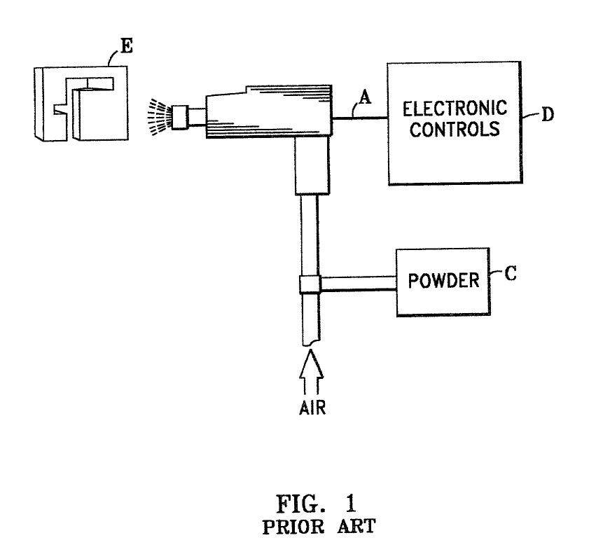

1. FIG. 1 is a schematic depiction of a prior art in use for powder coating purposes.

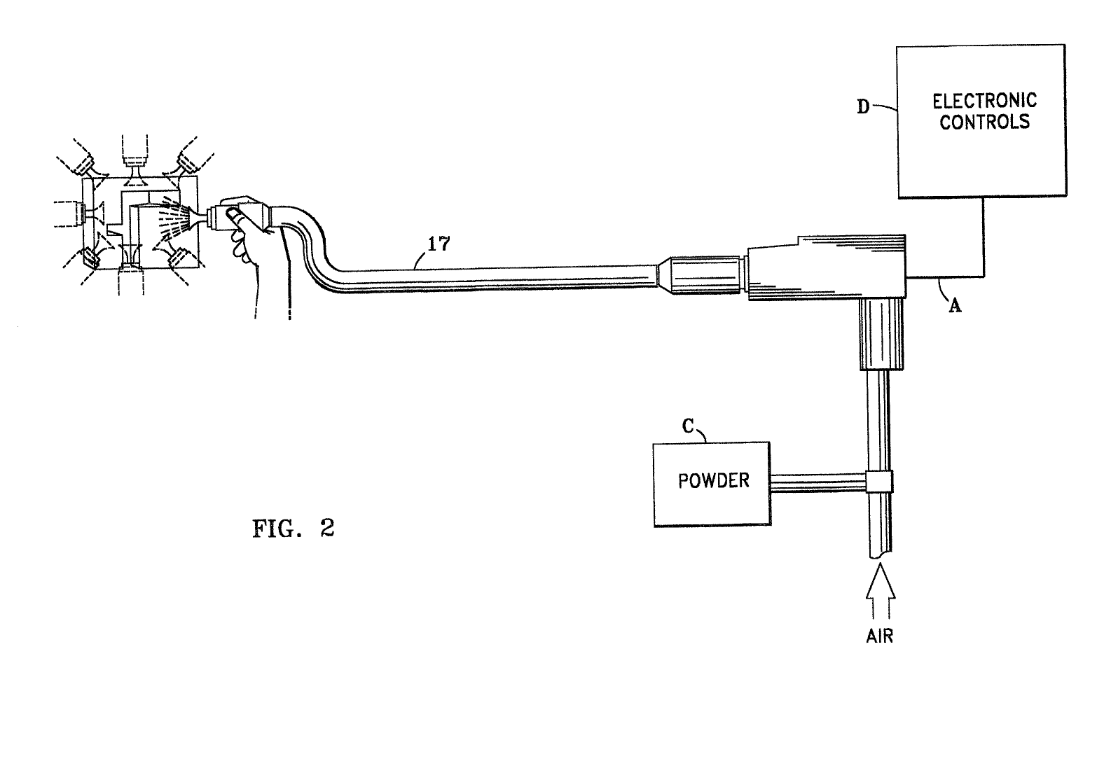

2. FIG. 2 is a schematic depiction of the invention in use for powder coating purposes.

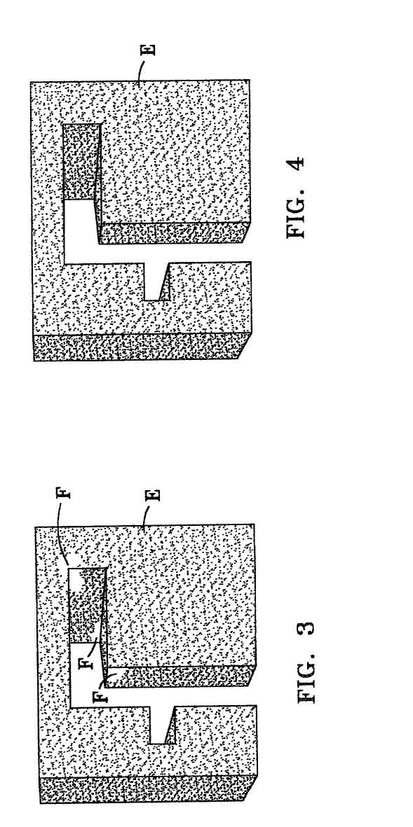

3. FIG. 3 is a depiction of a result obtained from use of prior art for powder coating purposes.

4. FIG. 4 is a is a depiction of the result obtained from use of the invention for powder coating purposes.

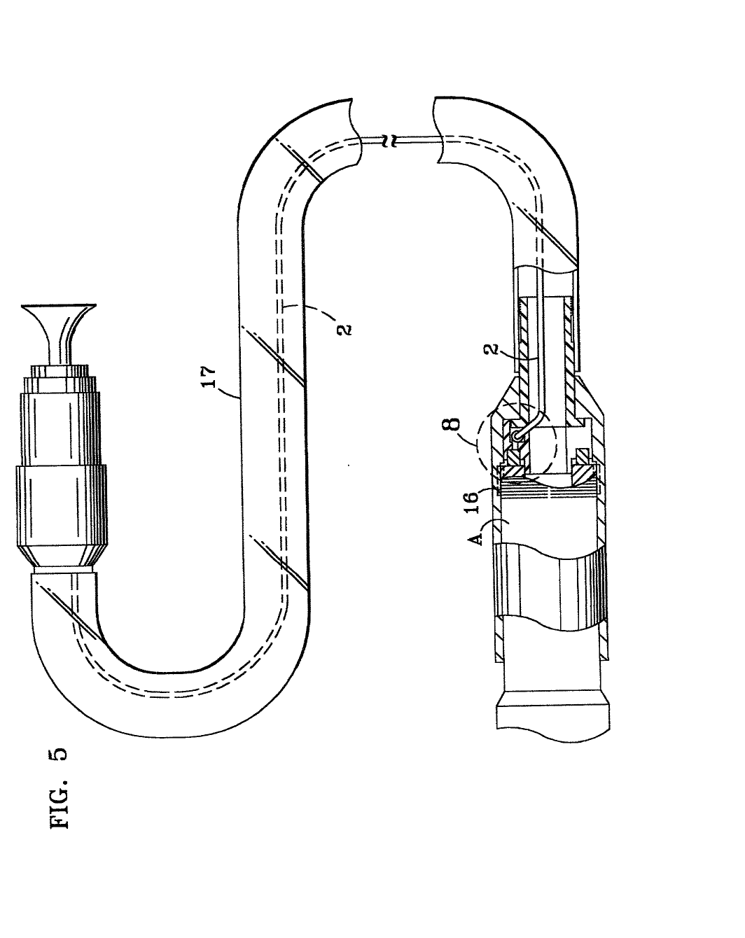

5. FIG. 5 is a broken lateral plan view of a first embodiment of the invention depicting a portion thereof cross-sectionally.

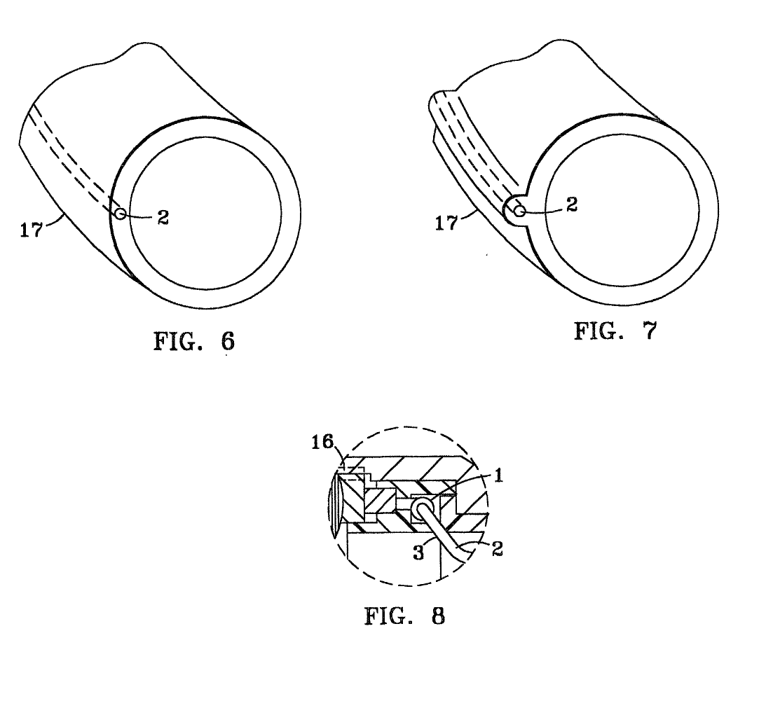

6. FIG. 6 is an isolated broken perspective view of flexible tubing in respect of a second

7. FIG. 7 is an isolated broken perspective view of a third embodiment of flexible tubing in respect of the invention.

8. FIG. 8 is an isolated view of a segment of that portion of the invention depicted cross-sectionally in FIG. 5.

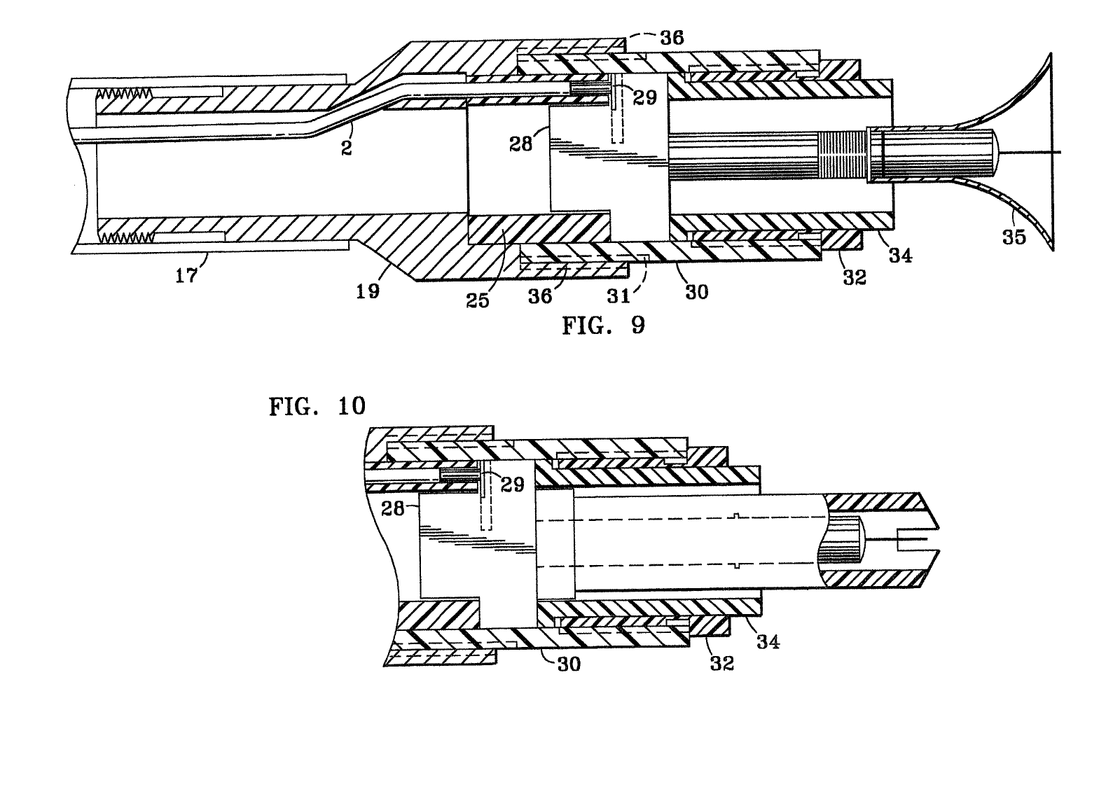

9. FIG. 9 is a cross-sectional depiction of that portion of the invention wherefrom charged powder particles emanate with use of a corona jet component.

10. FIG. 10 is a cross-sectional depiction of that portion of the invention wherefrom charged particles emanate with use of a flat jet component.

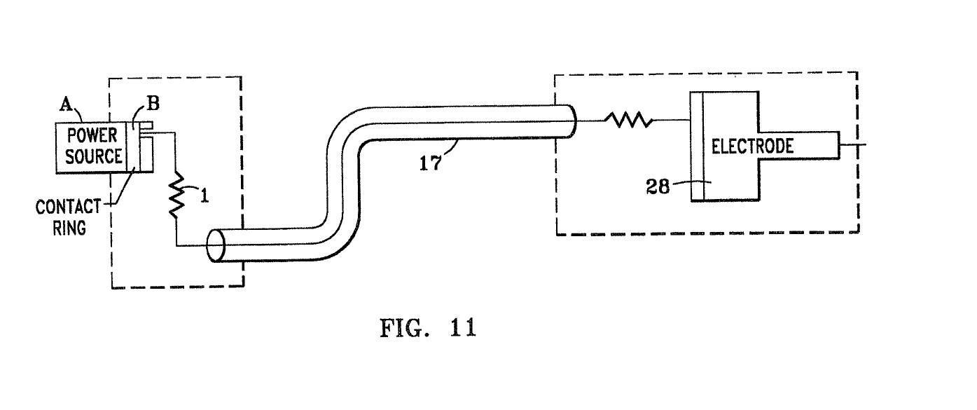

11. FIG. 11 is a schematic depiction of the invention.

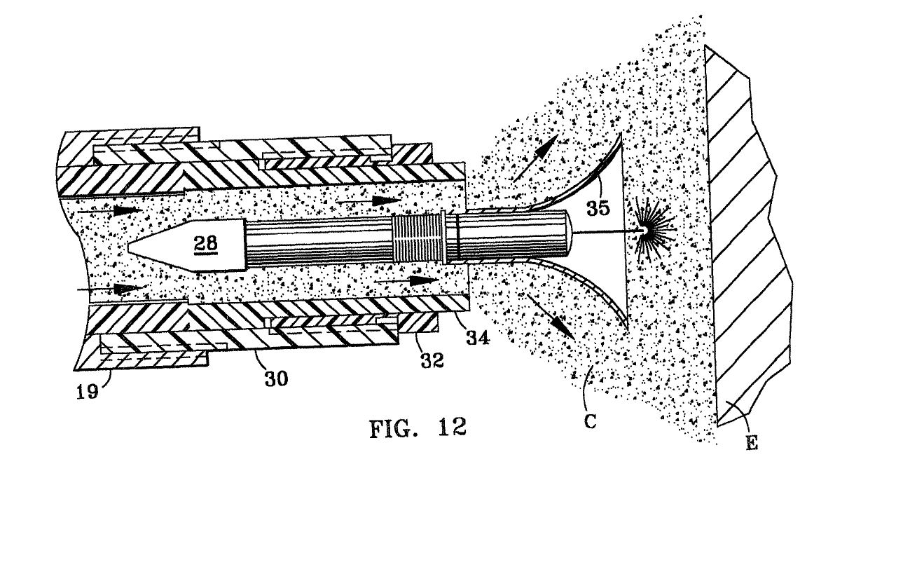

12. FIG. 12 is a cross-sectional depiction of powder particles emanating from the frontal aspect of the invention being charged as applied to a metallic surface.

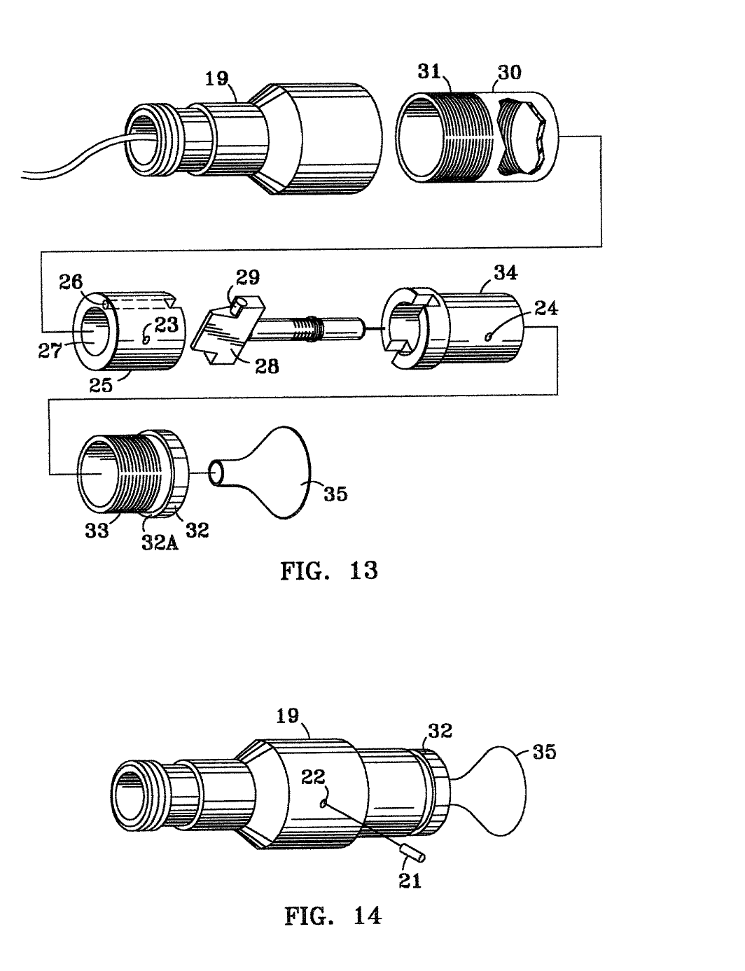

13. FIG. 13 is an exploded perspective view of various anterior components of the invention.

14. FIG. 14 is a perspective view of the components shown in FIG. 13 but assembled together.

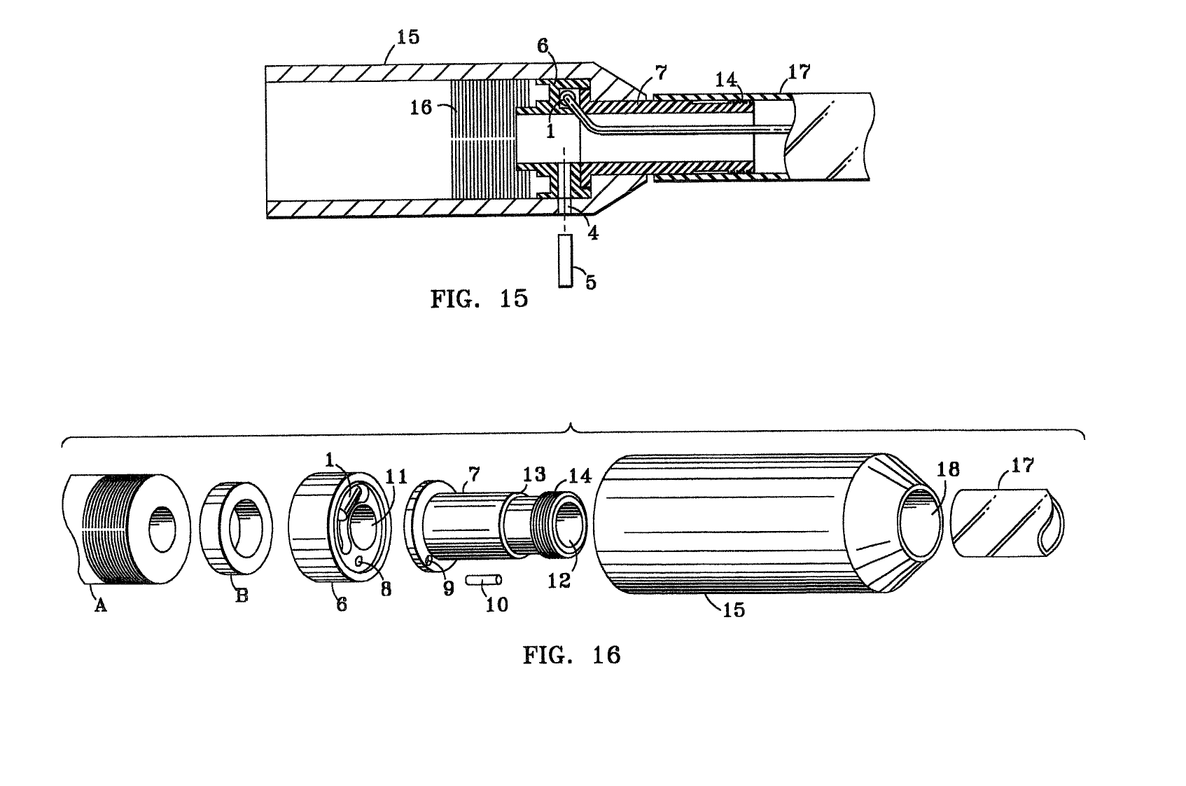

15. FIG. 15 is a cross-sectional view evidencing assembly of various posterior components of the invention.

16. FIG. 16 is an exploded perspective view of various posterior components of the invention.

### A DESCRIPTION OF THE PREFERRED EMBODIMENTS

FIG. 1 as contrasted with FIG. 2 illustrates the clear difference as between universally inflexible prior art in respect of charged powder particle application devices, in general, and the instant invention, a flexible charged powder particle application device. Powder C is processed forward from a powder reservoir G under pressure from, for example, forced air and, interactively with current from a power source A influenced by electronic controls D is ultimately deposited onto a metallic surface E. Flexible tubing component 17 of the invention with body and length is the unique feature that serves to markedly distinguish the invention from prior art devices in respect of the matter of depositing charged power particles in a form of painting application to metallic surfaces E. FIGS. 3 and 4 serve to illustrate the marked advantages of the invention vis a vis inflexible prior art devices. A comparison of FIG. 3 to FIG. 4 will, at once, facilitate the observation that bare, untreated spots F in metallic work E, remain after completion of a painting application process utilizing an inflexible prior art charged powder application device, are markedly absent in FIG. 4 where a resort to utilization of the instant invention was undertaken for such purposes. It is the unique feature of flexibility as respects the invention that serves to enable a user to achieve even, dependable and complete charged powder particle paint application to tightly positioned, relatively hard to reach nooks, crannies and corners in and about metallic objects, the surfaces of which are sought to be coated. FIG. 5 illustrates the essence of the invention more or less panoramically, as does FIG. 11 however in schematic fashion. Power from a power source A via a contact ring is introduced to a 15 meg resistor 1 housed within an electrode block unit 6 seen, for example in FIG. 16. Electrode block unit 6 abuts contact ring B that in turn abuts power source A as seen in FIG. 16 on the side of resistor 1 and opposite the side thereof in contact with ring B there is to be found wiring 2 soldered to resister 1 as seen for example, in FIGS. 5 and 8. Electrode block unit 6 is affixed at the anterior side thereof to the posterior end of an electrode block extension unit 7. Electrode block unit 6 and electrode block extension unit 7 are each characterized by the presence of electrode block centerhole 11 and electrode block extension centerhole 12 respectively to facilitate the passage of powder particles C flowing through units 6 and 7 under pressure from a powder reservoir G. Block housing 15 houses units 6 and 7, and, this, if you will, posterior aspect of the invention is held intact once assembled, by any one of various means. For example, a first pin 5 insertable into a first pinhole 4 extending through housing 15 and units 6 and 7 as shown in FIG. 15 is serviceable as a means of maintaining such assembly. Electrode block pinhole 8 in unit 6 and pinhole 9 in unit 7 receive second pin 10 as seen in FIG. 16 in order to prevent undesirable rotation of unit 7 in relation to unit 6 during actual operation of the invention in variant forms of the invention wherein unit 6 and unit 7 would not have been, for example, press fitted together during initial manufacture of the invention. The purpose of an electrode block extension unit 7 is to provide electrode block extension splines 14 shown in FIG. 16 to which one end of flexible tubing 17 is affixed. An electrode block extension relief surface 13 serves to prevent tubing 17 from riding posteriorly about unit 7 during operation of the invention. Power source affixation means 16, for example, threading about inner walling of block housing 15 serve to hold intact power source A, contact ring B and units 6 and 7 all within block housing 15. An anteriorly positioned housing through hole 18 in block housing 15 permits emanation therefrom of flexible tubing 17. FIGS. 5, 6 and 7 illustrate the manner in which wiring 2 is found within flexible tubing 17. In FIG. 5, in a first embodiment of the invention wiring 2 is shown as it courses alternatively through the lumen within flexible tubing 17 from where it is soldered to resistor 1. In FIG. 6, in a second embodiment, wiring 2 is shown built right into the body of flexible tubing 17 and so within flexible tubing 17 courses anteriorly from where it is soldered to resistor 1. In FIG. 7, wiring 2 in a third embodiment is also shown built into the body of flexible tubing 17, however, it is held within an external extrusion of the outer walling of flexible tubing 17 and courses accordingly anteriorly from the point where it is soldered to resistor 1. Suitable insulating material 3 circumscribes wiring 2 in the instance where as in FIG. 5, current in wiring 2 coursing anteriorly from resistor 1 must be prevented from contacting powder particles C flowing through the lumen of flexible tubing 17 from the locus of electrode block extension centerhole 12. FIGS. 13 and 14 illustrate, if you will, the anterior aspect of the invention. The anterior aspect of the invention in exploded perspective view in FIG. 13 is shown wholly assembled in FIG. 14. With resort to FIG. 13, an electrode base unit 25 is anteriorly assembled to an electrode unit 28. Located upon electrode unit 28 is electrode contact component 29. Within electrode base unit 25 there is to be found horizontally inclined wiring through hole 26 and electrode base centerhole 27. Wiring 2 within flexible tubing 17 ultimately passes through wiring through hole 26 to make contact with electrode contact component 29 while powder coursing under pressure from within the lumen of flexible tubing 17 enters electrode base centerhole 27. Hollow adapter nozzle 34 is posteriorly affixable to electrode unit 28 as is also evidenced with resort to FIG. 13. Adapter nozzle 34 has either a wholly open anterior end to accommodate affixation of a corona deflector 35 to an anterior end of electrode unit 28 or the anterior end thereof is closed but for a slit therein. An electrode hub unit 19 serves to house electrode base unit 25, electrode unit 28 and adapter nozzle 34 as well as to posteriorly consist of hub splines 20 which a second end of flexible tubing 17 is affixed. A base bushing unit 30 is equipped with means, for instance, threading 31 for affixation of base bushing unit 30 via threading 36 on interior walling of electrode hub unit 19 to the interior of electrode hub unit 19. Base bushing unit 30 posteriorly accepts and concomitantly stabilizes, within electrode hub unit 19, the complex made up of conjoined electrode base unit 25, electrode unit 28 and adapter nozzle 34. An adapter screw lock unit 32 equipped with means, for instance, threading 33 for affixation of adapter screw lock unit 32 to i.e., threading 37 on the interior walling of base bushing unit 30 serves to stabilize the position of base bushing unit 30 within electrode hub unit 19 via a relief surface 32A located anteriorly upon the exterior of adapter screw lock unit 32. A hub pin 21 insertable into a hub pinhole 22 within electrode hub unit 19, and in turn insertable into a base pinhole 23 within electrode base unit 25 provides an optimal means of further stabilizing the above-referenced complex within electrode hub unit 19. Hub pinhole 22 could moreover optimally be moved anteriorly on electrode hub unit 19 to accommodate insertion of hub pin 21 into a nozzle pinhole 24 to accomplish the same purpose. FIG. 9 illustrates cross-sectionally the assembly of components depicted in FIG. 14. FIG. 12 cross-sectionally illustrates the flow of powder particles C under pressure coursing as illustrated with arrows through electrode base unit 25, about electrode unit 28, through adapter nozzle 34 and then under pressure out and about corona deflector 35 where they come into contact with a charged tip of electrode unit 28 to then themselves acquire charge to facilitate deposit of such particles upon a metallic surface E. Removal of an open-ended adapter nozzle 34 and corona deflector 35 and insertion instead of a slit-ended adapter nozzle 34 as seen in FIG. 10 in place of the open-ended adapter nozzle 34, within the slit of which the charged tip of electrode unit 28 would be found serves to facilitate tighter application of powder particles C emanating to and through the slit and coming into contact with the charged tip of electrode unit 28, to a metallic surface E. The novel combination of those components of the invention such as the electrode block extension unit 7, the electrode base unit 25 and electrode hub unit 19 is occasioned as a means of accommodating the need for the presence of electrode block splines 14 and electrode hub splines 20 in order to hold and stabilize in place the novel component, flexible housing 17 of the invention.

In conclusion, it is once again respectfully submitted, that the invention is not merely new, useful and unique, but is, moreover, indeed virtually revolutionary in the art of charged powder particle application devices:

What is claimed is

1. A Flexible Charged Powder Particle Application Device, comprising:
a) 15 meg resistor;
b) wiring with length affixed to said resistor;
c) an electrode block unit housing said resistor affixed therein;
d) an electrode block extension unit affixed at a posterior end thereof to an anterior side of said electrode block unit;
e) an electrode block centerhole within said electrode block unit;
f) an electrode block extension centerhole within said electrode block extension unit;
g) an electrode block extension relief surface;
h) electrode block extension unit splines located near an anterior end of said electrode block extension unit;
i) a hollow block housing unit housing said electrode block unit and said electrode block extension unit with a through hole at an anterior end of said block housing unit;
j) means within said hollow block housing unit for affixation to said hollow block housing unit of an external power source to which a posterior side of said electrode block is connected via a contact ring unit;
k) flexible tubing with body and length affixed at a first end to said electrode block extension unit splines;
l) an electrode hub unit;
m) electrode hub unit splines located near a posterior end of said electrode hub unit;
n) said flexible tubing being affixed at a second end thereof to said electrode hub unit splines;
o) an electrode base unit;
p) said electrode base unit having a horizontally inclined center through hole;
q) said electrode base unit having a horizontally inclined wiring through hole in a body thereof;
r) an electrode unit;
s) an electrode contact component affixed to said electrode unit;
t) a hollow base bushing unit;
u) said electrode base unit being anteriorly attached to a posterior portion of said electrode unit;
v) an adapter nozzle posteriorly attached to said electrode unit;
w) said base bushing unit being affixed at outer walling thereof to inner walling of said electrode hub unit;
x) said base bushing unit holding said adapter nozzle and in turn said electrode unit and in turn said electrode base unit within said electrode hub unit;
y) an adapter screw lock unit attachable about an anterior end of said electrode hub unit by way of affixation of said adapter screw lock unit at outer walling thereof to inner walling of said base bushing unit, and;
z) said wiring traversing said length of said flexible tubing within said flexible tubing beginning from a locus of said resistor and coursing through said wiring through hole and terminating affixed to said electrode contact component.

2. The flexible charged powder particle application device of claim 1., whereby, said wiring along said length of said wiring is circumscribed by insulating material.

3. A Flexible Charged Powder Particle Application Device, comprising:
a) a 15 meg resistor;
b) wiring with length affixed to said resistor;
c) an electrode block unit housing said resistor affixed therein;
d) an electrode block extension unit affixed at a posterior end thereof to an anterior side of said electrode block unit;
e) an electrode block centerhole within said electrode block unit;
f) an electrode block extension centerhole within said electrode block extension unit;
g) an electrode block extension relief surface;
h) a horizontally inclined first pinhole in a posterior portion of said electrode block extension unit;
i) a horizontally inclined second pinhole in an anterior side of said electrode block unit;
j) a pin insertable into said first pinhole and into said second pinhole;
k) electrode block extension unit splines located near an anterior end of said electrode block extension unit;
l) a hollow block housing unit housing said electrode block unit and said electrode block extension unit with a through hole at an anterior end of said block housing unit;
m) means within said hollow block housing unit for affixation to said hollow block housing unit of an external power source to which a posterior side of said electrode block is connected via a contact ring unit;
n) flexible tubing with body and length affixed at a first end to said electrode block extension unit splines;
o) an electrode hub unit;
p) electrode hub unit splines located near a posterior end of said electrode hub unit;
q) said flexible tubing being affixed at a second end thereof to said electrode hub unit
r) an electrode base unit;
s) said electrode base unit having a horizontally inclined center through hole;
t) said electrode base unit having a horizontally inclined wiring through hole in a body thereof;
u) an electrode unit;
v) an electrode contact component affixed to said electrode unit;
w) a hollow base bushing unit;
x) said electrode base unit being anteriorly attached to a posterior portion of said electrode unit;
y) an adapter nozzle posteriorly attached to said electrode unit;
z) said base bushing unit being affixed at outer walling thereof to inner walling of said electrode hub unit;
aa) said base bushing unit holding said adapter nozzle and in turn said electrode unit and in turn said electrode base unit within said electrode hub unit;
bb) an adapter screw lock unit attachable about an anterior end of said electrode hub unit by way of affixation of said adapter screw lock unit at outer walling thereof to inner walling of said base bushing unit, and;
cc) said wiring traversing said length of said flexible tubing within said flexible tubing beginning from a locus of said resistor and coursing through said wiring through hole and terminating affixed to said electrode contact component.

4. The flexible charged powder particle application device of claim 3., whereby, said wiring along said length of said wiring is circumscribed by insulating material.

5. A Flexible Charged Powder Particle Application Device, comprising:
a) electrode block extension unit splines located near an anterior end of said electrode block extension unit;
b) a hollow block housing unit housing said electrode block unit and said electrode block extension unit with a through hole at an anterior end of said block housing unit;
c) means within said hollow block housing unit for affixation to said hollow block housing unit of an external power source to which a posterior side of said electrode block is connected via a contact ring unit;
d) an electrode block extension unit affixed at a posterior end thereof to an anterior side of said electrode block unit;
e) an electrode block centerhole within said electrode block unit;
f) an electrode block extension centerhole within said electrode block extension unit;
g) an electrode block extension relief surface;
h) electrode block extension unit splines located near an anterior end of said electrode block extension unit;
i) a hollow block housing unit housing said electrode block unit and said electrode block extension unit with a through hole at an anterior end of said block housing unit;
j) means within said hollow block housing unit for affixation to said hollow block housing unit of an external power source to which a posterior side of said electrode block is connected via a contact ring unit;
k) flexible tubing with body and length affixed at a first end to said electrode block
l) an electrode hub unit;
m) electrode hub unit splines located near a posterior end of said electrode hub unit;
n) said flexible tubing being affixed at a second end thereof to said electrode hub unit splines;
o) an electrode base unit;
p) said electrode base unit having a horizontally inclined center through hole;
q) said electrode base unit having a horizontally inclined wiring through hole in a body thereof;
r) an electrode unit;
s) an electrode contact component affixed to said electrode unit;
t) a hollow base bushing unit;
u) said electrode base unit being anteriorly attached to a posterior portion of said electrode unit;
v) an adapter nozzle posteriorly attached to said electrode unit;
w) said base bushing unit being affixed at outer walling thereof to inner walling of said electrode hub unit;
x) said base bushing unit holding said adapter nozzle and in turn said electrode unit and in turn said electrode base unit within said electrode hub unit;
y) an adapter screw lock unit attachable about an anterior end of said electrode hub unit by way of affixation of said adapter screw lock unit at outer walling thereof to inner walling of said base bushing unit, and;
z) said wiring traversing said length of said flexible tubing within said body of said flexible tubing beginning from a locus of said resistor and coursing through said wiring through hole and terminating affixed to said electrode contact component.

6. A Flexible Charged Powder Particle Application Device, comprising:
a) a 15 meg resistor;
b) wiring with length affixed to said resistor;
c) an electrode block unit housing said resistor affixed therein;
d) an electrode block extension unit affixed at a posterior end thereof to an anterior side of said electrode block unit;
e) an electrode block centerhole within said electrode block unit;
f) an electrode block extension centerhole within said electrode block extension unit;
g) an electrode block extension relief surface;
h) a horizontally inclined first pinhole in a posterior portion of said electrode block extension unit;
i) a horizontally inclined second pinhole in an anterior side of said electrode block unit;
j) a pin insertable into said first pinhole and into said second pinhole;
k) electrode block extension unit splines located near an anterior end of said electrode block extension unit;
l) a hollow block housing unit housing said electrode block unit and said electrode block extension unit with a through hole at an anterior end of said block housing unit;
m) means within said hollow block housing unit for affixation to said hollow block housing unit of an external power source to which a posterior side of said electrode block is connected via a contact ring unit;
n) flexible tubing with body and length affixed at a first end to said electrode block extension unit splines;
o) an electrode hub unit;
p) electrode hub unit splines located near a posterior end of said electrode hub unit;
q) said flexible tubing being affixed at a second end thereof to said electrode hub unit splines;
r) an electrode base unit;
s) said electrode base unit having a horizontally inclined center through hole;
t) said electrode base unit having a horizontally inclined wiring through hole in a body thereof;
u) an electrode unit;
v) an electrode contact component affixed to said electrode unit;
w) a hollow base bushing unit;
x) said electrode base unit being anteriorly attached to a posterior portion of said electrode unit;
y) an adapter nozzle posteriorly attached to said electrode unit;
z) said base bushing unit being affixed at outer walling thereof to inner walling of said electrode hub unit;
aa) said base bushing unit holding said adapter nozzle and in turn said electrode unit and in turn said electrode base unit within said electrode hub unit;
bb) an adapter screw lock unit attachable about an anterior end of said electrode hub unit by way of affixation of said adapter screw lock unit at outer walling thereof to inner walling of said base bushing unit, and;
cc) said wiring traversing said length of said flexible tubing within said body of said flexible tubing beginning from a locus of said resistor and coursing through said wiring through hole and terminating affixed to said electrode contact component.
